(19) United States
(12) Patent Application Publication
(10) Pub. No.: US 2010/0259019 A1
(43) Pub. Date: Oct. 14, 2010

(54) Golf Transportation System

(75) Inventor: Len T. Orr, Jamestown, ND (US)

Correspondence Address: NEUSTEL LAW OFFICES, LTD., 2534 SOUTH UNIVERSITY DRIVE, SUITE 4, FARGO, ND, 58103, US

(73) Assignee: Caddie Wheels, Inc.

(21) Appl. No.: 12/650,002

(22) Filed: Dec. 30, 2009

Related U.S. Application Data
(60) Provisional application No. 61/212,542, filed on Apr. 13, 2009.

(51) Int. Cl. B62B 3/02

(52) U.S. Cl. 280/30

(57) ABSTRACT

A golf transportation system for enabling the transportation of one or more sets of golf clubs and golf bags in a small, light and secure protective case. The golf transportation system generally includes a travel case with a handle attached to its first end and a pair of wheel assemblies removably attached to its second end. Each wheel assembly is comprised of a first wheel member removably attached to a second wheel member. When separated, the wheel members may be connected to an outer covering to form a golf bag. The first wheel member acts as the lower end of the golf bag and the second wheel member acts as the upper end of the golf bag from which golf clubs project. By utilizing the present invention, two full sets of golf clubs and a pair of golf bags may be transported in a single travel case.

### CROSS REFERENCE TO RELATED APPLICATIONS

I hereby claim benefit under Title 35, United States Code, Section 119(e) of U.S. provisional patent application Ser. No. 61/212,542 filed Apr. 13, 2009. The 61/212,542 application is currently pending. The 61/212,542 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a travel system for golf bags, clubs and accessories and more specifically it relates to a golf transportation system for enabling the transportation of one or more sets of golf clubs and golf bags in a small, light and secure protective case.

2. Description of the Related Art

Any discussion of the related art throughout the specification should in no way be considered as an admission that such related art is widely known or forms part of common general knowledge in the field.

Since the advent of air travel, golf enthusiasts have struggled with transporting their golf clubs, bags and accessories to different locales for golfing. In recent times, airlines have been charging substantial fees for the transport of checked bags on an airplane. Golfers who live in colder climates are particularly susceptible to such charges, as they are generally forced to fly to warmer climates during colder months to enjoy their sport. Such golfers are generally forced to either pay the exorbitant fees for checking their golf clubs, bags and accessories or, in the alternative, rent golf clubs with which they are unfamiliar when they arrive at their destination.

Previously existing transportation systems for golf are generally comprised of fully enclosed golf bags which require payment of a checked bag fee for each set of golf clubs. The existing art does not appear to provide a method for a golfer to travel with more than one set of clubs and bags without paying for more than one checked bag.

Because of the inherent problems with the related art, there is a need for a new and improved golf transportation system for enabling the transportation of one or more sets of golf clubs and golf bags in a small, light and secure protective case.

### BRIEF SUMMARY OF THE INVENTION

A system for enabling the transportation of one or more sets of golf clubs and golf bags in a small, light and secure protective case. The invention generally relates to a golf transportation system which includes a travel case with a handle attached to its first end and a pair of wheel assemblies removably attached to its second end. Each wheel assembly is comprised of a first wheel member and a second wheel member, wherein the wheel members are removably attached to each other. When separated, the first wheel member and second wheel member may be connected to an outer covering to form a golf bag, with the first wheel member acting as the lower end of the golf bag and the second wheel member acting as the upper end of the golf bag from which golf clubs project.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an exploded upper perspective view of the present invention.

FIG. 3 is a top view of the present invention with the cover opened.

FIG. 4 is an upper perspective view of a wheel assembly of the present invention.

FIG. 5 is an exploded upper perspective view of a wheel assembly of the present invention.

FIG. 6 is an exploded upper perspective view of an upper wheel member, outer covering and lower wheel member of the present invention.

FIG. 7 is an upper perspective view of a golf bag formed from an upper wheel member, outer covering and lower wheel member of the present invention.

FIG. 8 is a bottom view of a golf bag formed from an upper wheel member, outer covering and lower wheel member of the present invention.

### DETAILED DESCRIPTION OF THE INVENTION

### A. Overview.

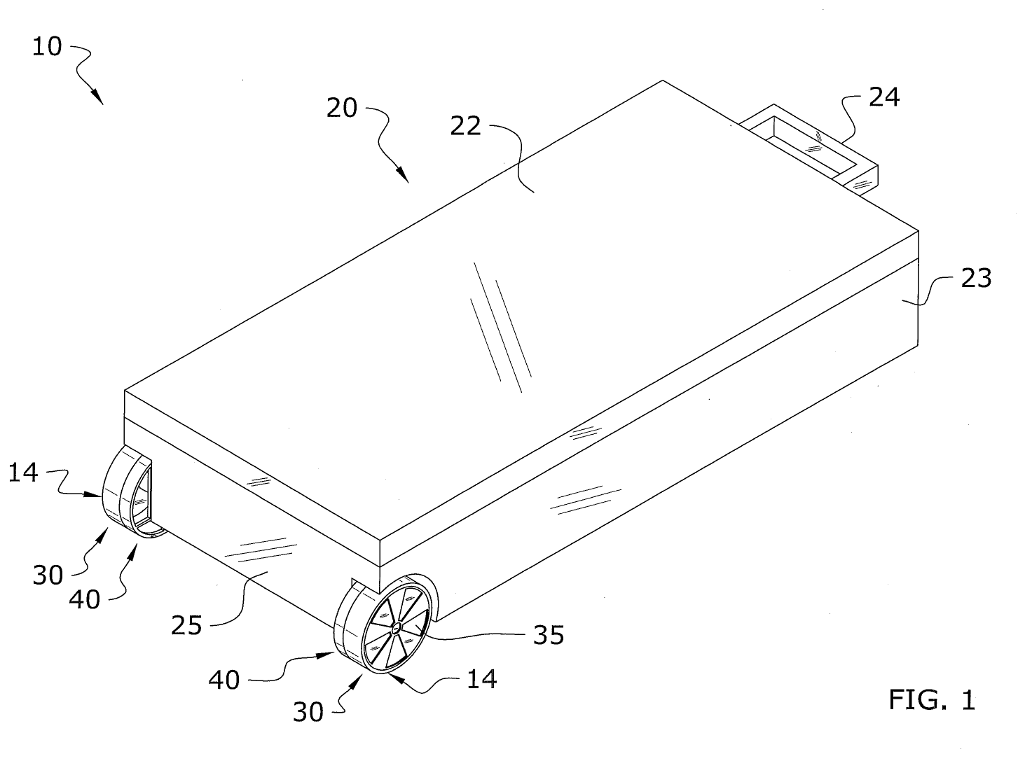

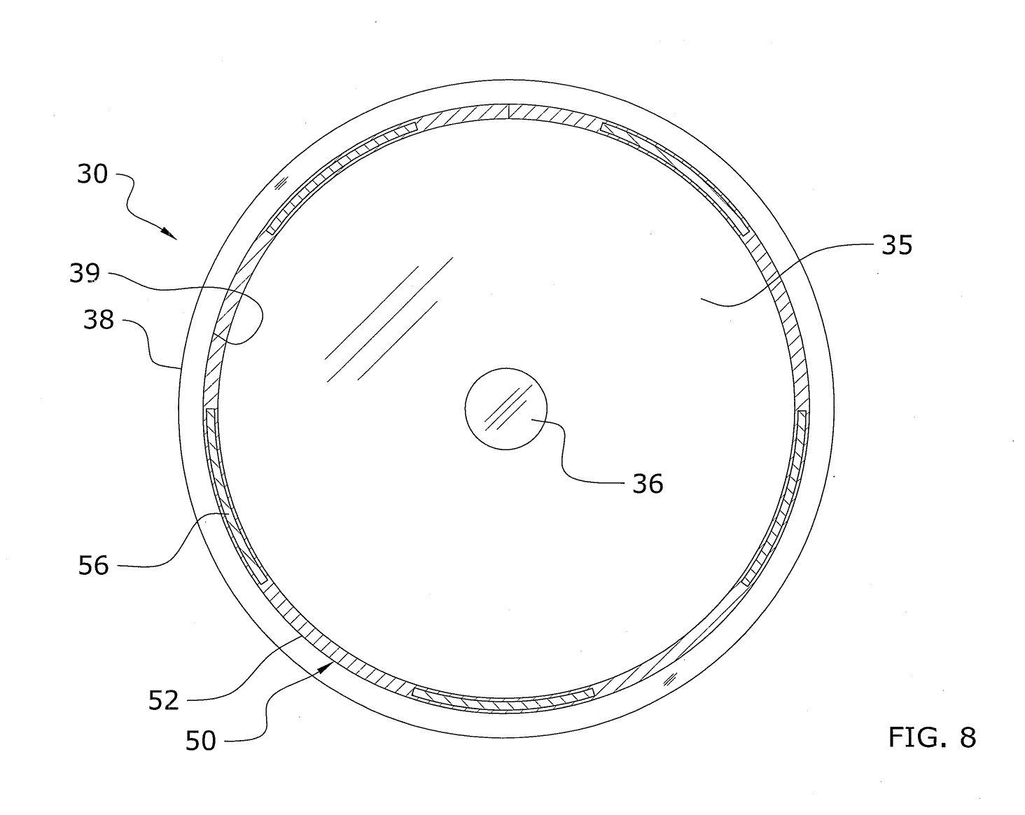

Turning now descriptively to the drawings, in which similar reference characters denote similar elements throughout the several views, FIGS. 1 through 8 illustrate a golf transportation system 10, which comprises a travel case 20 with a handle 24 attached to its first end 23 and a pair of wheel assemblies 14 removably attached to its second end 25. Each wheel assembly 14 is comprised of a first wheel member 30 and a second wheel member 40, wherein the wheel members 30, 40 are removably attached to each other. When separated, the first wheel member 30 and second wheel member 40 may be connected to an outer covering 50 to form a golf bag 11, with the first wheel member 30 acting as the lower end of the golf bag 11 and the second wheel member 40 acting as the upper end of the golf bag 11 from which golf clubs 12 project.

### B. Travel Case.

The present invention will generally include a travel case 20 for transporting golf clubs 12, golf bags 11 and golf accessories to and from a destination. As shown in FIG. 1, the travel case 20 of the present invention will generally be comprised of an enclosed case having a first end 23 and a second end 25. A handle 24 will preferably be included on the first end 23 of the travel case 20 for the golfer to grasp and pull the travel case 20.

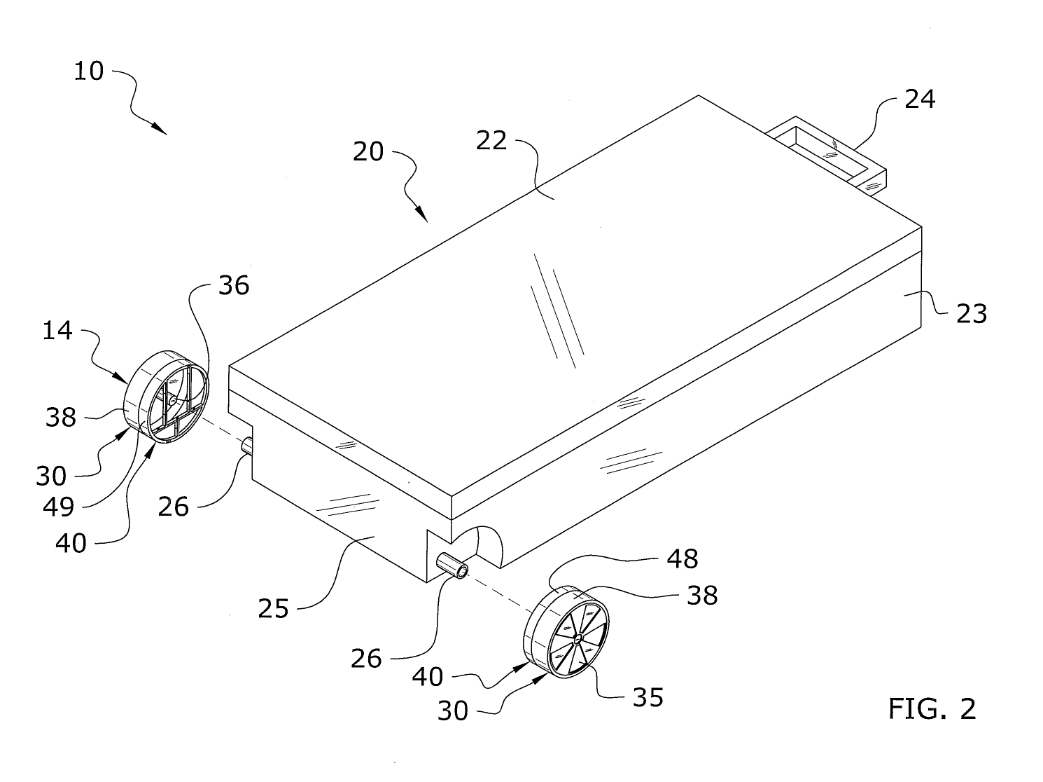

An axle member 26 will generally be included on the second end 25 of the travel case 20 for supporting the wheel assemblies 14 of the present invention when it is pulled by its handle 24. The axle member 26 will preferably be comprised of a rod or other projection which is adapted to be inserted into an axle receiving member 36 as illustrated in FIG. 2. It is appreciated that the handle 24 and axle member 26 may be placed at different locations on the travel case 20 without affecting the overall operation of the present invention so long as the travel case 20 is capable of being easily transported by a golfer without undue strain.

The travel case 20 of the present invention may be comprised of various materials, shapes and designs, and should not be limited to the embodiment shown in the figures. In a preferred embodiment, the travel case 20 will be comprised of a resilient plastic material which is capable of withstanding the rigors of air travel, including abuse by baggage handlers, without bending, warping, scratching or suffering substantial structural damage. However, it is appreciated that other materials may be utilized for the travel case 20, including metals and metal alloys, so long as the material being utilized is similarly capable of withstanding the rigors of air travel.

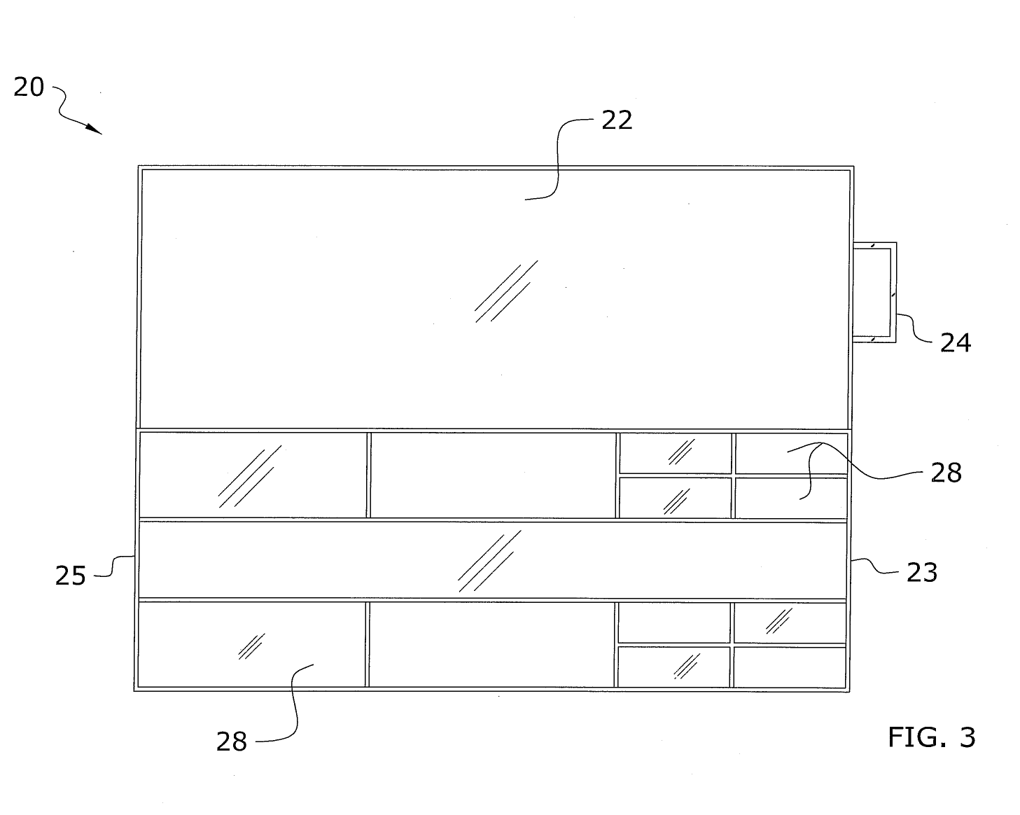

The travel case 20 will generally include a hinged cover 22 as shown in FIG. 3. The cover 22 will generally swing open to review the interior of the travel case 20, which will preferably include one or more storage compartments 28 for storing golf clubs 12 and other accessories while the present invention is in use. However, it is appreciated that various other embodiments of the cover 22 may be utilized other than a hinged configuration. For example, the cover 22 could slide open in some embodiments.

Storage compartments 28 will preferably be included in the travel case 20 for at least two pairs of golf shoes, two sets of golf clubs 12, tees, golf balls and the support members 56 of the present invention. However, it is appreciated that various other embodiments of the interior of the travel case 20 may be utilized without affecting the overall operation of the present invention so long as sufficient space is provided to safely store golf clubs 12 and other accessories while the present invention is being transported to different locations. In a preferred embodiment, the interior of the travel case 20 will include soft surfaces, such as padding, so as to protect the golf clubs 12 and other accessories from damage while being transported.

### C. Wheel Assemblies.

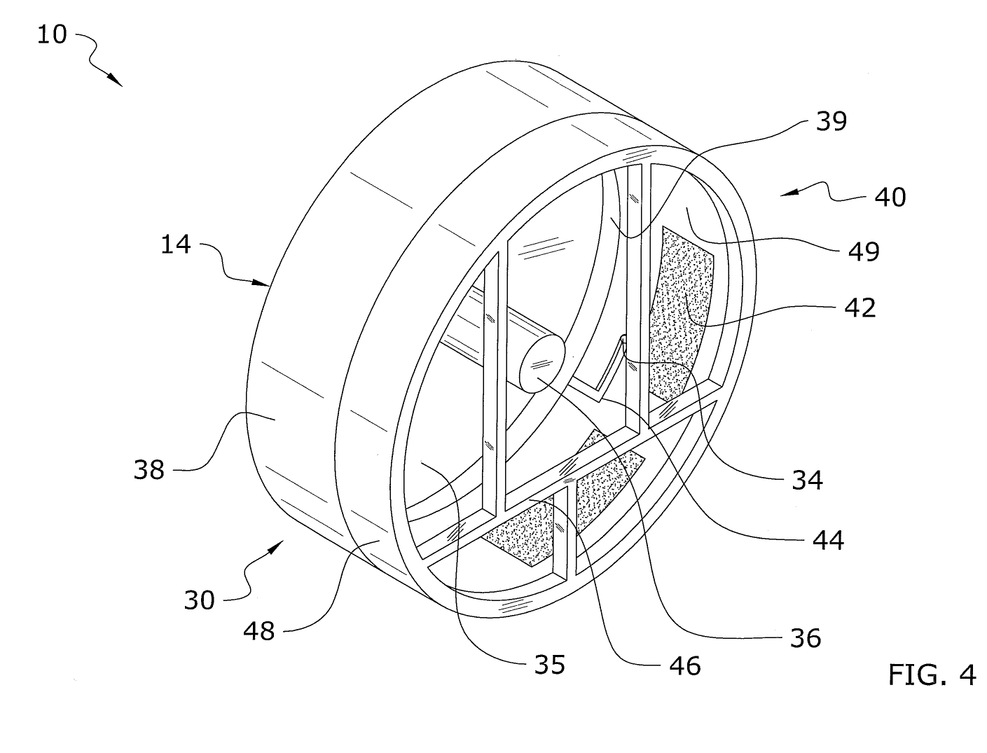

FIG. 4 illustrates a preferred embodiment of a wheel assembly 14 of the present invention. Each wheel assembly 14 will generally be removably attachable to the axle members 26 of the present invention so as to allow the travel case 20 to be mobile. The wheel assemblies 14 of the present invention will preferably be substantially round so as to allow them to easily traverse the ground when the travel case 20 is transported. Further, while it is preferred that a pair of wheel assemblies 14 be utilized with the present invention (i.e. with each wheel assembly 14 on opposite sides of the travel case as shown in FIG. 1), it is appreciated that more or less wheel assemblies 14 may be utilized in different areas on the travel case 20 without affecting the overall operation of the present invention.

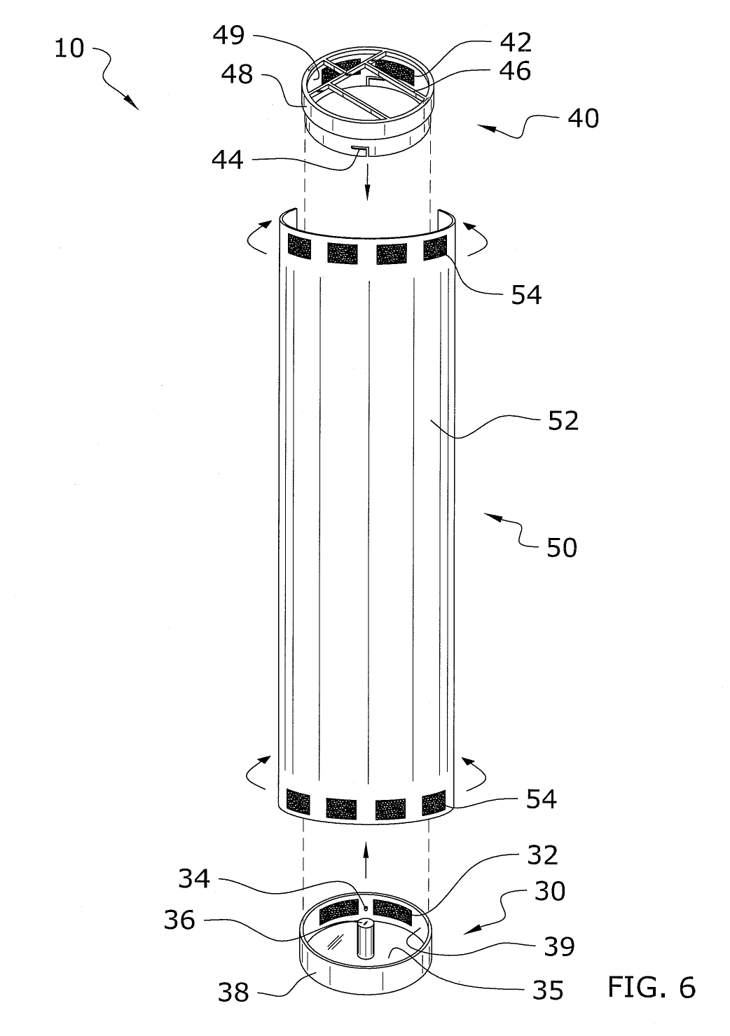

Each wheel assembly 14 of the present invention will preferably be comprised of a first wheel member 30 removably attached to a second wheel member 40, wherein the wheel members 30, 40 are convertible into the upper end and lower end of a golf bag 11 as shown in FIG. 6.

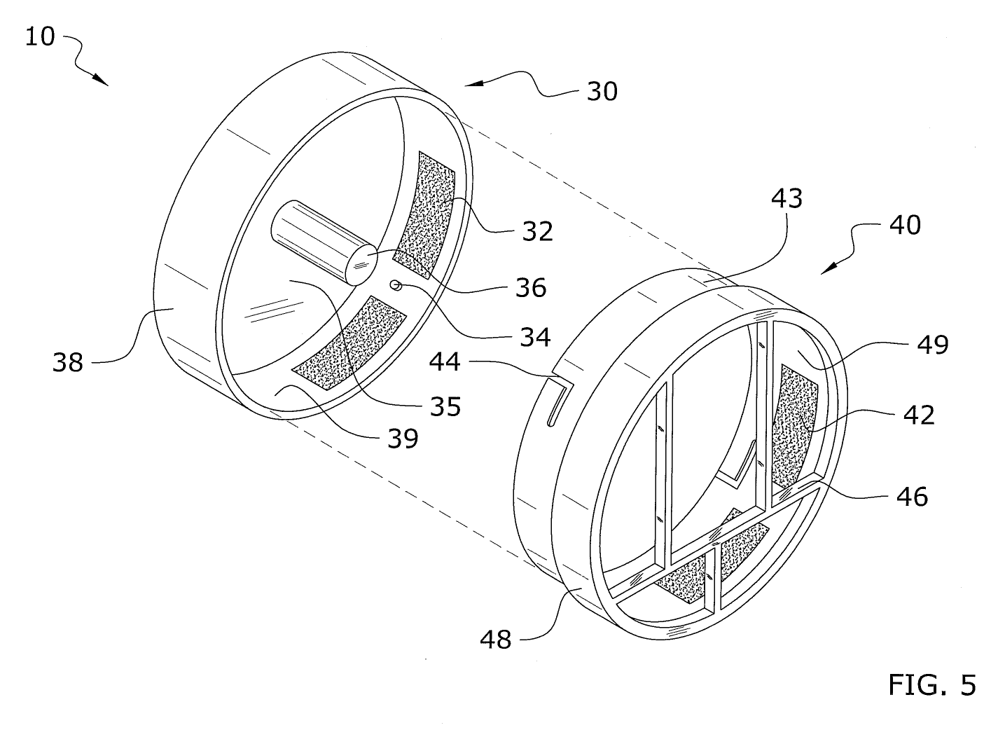

The first wheel member 30 will preferably be comprised of a substantially round ring member having an outer cover 35 on one side and an open face on the other side, as shown in FIG. 5. The first wheel member 30 will preferably be adapted to be used as the lower end of a golf bag 11 as shown in FIG. 6. The outer cover 35 of the first wheel member 30 will generally act as a “hub cab”, and may include designs to increase the aesthetic value of the present invention as shown in FIG. 1. The outer cover 35 will preferably include an axle receiving member 36 for receiving the axle member 26 of the travel case 20 when the wheel assemblies 14 are attached to the travel case 20. The axle receiving member 36 may be comprised of any structure capable of rotatably receiving an axle member 26, but is preferably comprised of a substantially cylindrical indentation in the outer cover 35 as shown in FIG. 5. The wheel assembly 14 will preferably rotate around the axle member 26 so as to provide motion to the travel case 20 when in use.

The first wheel member 30 will generally include an outer surface 38 comprised of the outer circumference of the first wheel member 30. The outer surface 38 will preferably be comprised of a material which is capable of withstanding the rigors of day-to-day use, including travelling over escalators and blunt impact when the travel case 20 is dropped.

The first wheel member 30 will also generally include an inner surface 39 comprised of the inner circumference of the first wheel member 30. The inner surface 39 of the first wheel member 30 will preferably include at least one locking member 34 comprised of a projection facing inward of the inner surface 39 as shown in FIG. 5. The locking member 34 will preferably be configured to lock the first wheel member 30 to the second wheel member 40 to form a wheel assembly 14 when inserted within the locking slot 44 of the second wheel member 40. In a preferred embodiment, a pair of locking members 34 will be utilized, with one on either side of the first wheel member 30.

The inner surface 39 of the first wheel member 30 will also preferably include at least one fastener 32 for securing the first wheel member 30 to the lower end of the golf bag 11 covering 50 of the present invention. The fastener 32 of the inner surface 39 of the first wheel member 30 may be comprised of various configurations, but is preferably comprised of a hook and loop fastener such as Velcro. Further, in a preferred embodiment, a plurality of strips of fastener 32 will be included on the inner surface 39 of the first wheel member 30 as shown in FIG. 5. Such a configuration allows for a secure connection between the first wheel member 30 and the outer covering 50 when the present invention is being utilized as a golf bag 11.

The second wheel member 40 will preferably be comprised of a substantially round ring member having at least one divider member 46 on one side and an open face on the other side, as shown in FIG. 5. The second wheel member 40 will preferably be adapted to be used as the upper end of a golf bag 11 as shown in FIG. 6, with the divider members 46 being utilized to separate different types of golf clubs 12 from each other. The divider members 46 may be comprised of various configurations, but will generally be comprised of metal or plastic elongated members which divide the outer opening of the second wheel member 40 into different sections as shown in FIG. 5.

The second wheel member 40 will generally include an outer surface 48 comprised of the outer circumference of the first wheel member 40. The outer surface 48 will preferably be comprised of a material which is capable of withstanding the rigors of day-to-day use, including travelling over escalators and blunt impact when the travel case 20 is dropped.

The second wheel member 40 will also generally include a recessed surface 43 which is recessed slightly from the outer surface 48 of the second wheel member as shown in FIG. 5. The recessed surface 43 is preferably recessed from the outer surface 48 of the second wheel member 40 so as to create a smooth connection between the outer surface 38 of the first wheel member 30 and the outer surface 48 of the second wheel member 40 when the wheel members 30, 40 are conjoined to form a wheel assembly 14 as shown in FIG. 4.

The recessed surface 43 will also generally include at least one locking slot 44 for receiving and engaging with the locking member 34 of the inner surface 39 of the first wheel member 30. Although the figures illustrate the use of a pair of locking slots 44, with one locking slot 44 positioned on either side of the circumference of the second wheel member 40, it is appreciated that various other numbers and placement of locking slots 44 may be utilized.

The locking slot 44 of the present invention will generally be comprised of a slot formed within the recessed surface 43 of the second wheel member 40 and may be comprised of various shapes and sizes, so long as it effectively engages with the locking member 34 when in use. In a preferred embodiment, the locking slot 44 is comprised of an L-shaped configuration as shown in FIG. 5.

The second wheel member 40 will also generally include an inner surface 49 comprised of the inner circumference of the second wheel member 40. The inner surface 49 of the second wheel member 40 will preferably include at least one fastener 42 for securing the second wheel member 40 to the upper end of the outer covering 50 of the present invention. The fastener 42 of the inner surface 49 of the second wheel member 40 may be comprised of various configurations, but is preferably comprised of a hook and loop fastener such as Velcro. Further, in a preferred embodiment, a plurality of strips of fastener 42 will be included on the inner surface 49 of the second wheel member 40 as shown in FIG. 5. Such a configuration allows for a secure connection between the second wheel member 40 and the outer covering 50 when the present invention is being utilized as a golf bag 11.

### D. Outer Covering.

The present invention will generally include an outer covering 50 which may be combined with the first wheel member 30 and second wheel member 40 to form a golf bag 11. As shown in FIG. 6, the first wheel member 30 will generally be comprised of the lower end of the golf bag 11, the second wheel member 40 will generally be comprised of the upper end of the golf bag 11 and the outer covering 50 will generally be comprised of the body of the golf bag 11 when formed. When the outer covering 50 is not in use, it will generally be stored in the storage compartment 28 of the travel case 20.

The outer covering 50 will generally be comprised of a durable and flexible material such as nylon, though it is appreciated that other flexible materials may be utilized so long as they are capable of withstanding the rigors of being utilized as the outer covering 50 of a golf bag 11, including the potential for blunt impact with other objects and exposure to wind and rain.

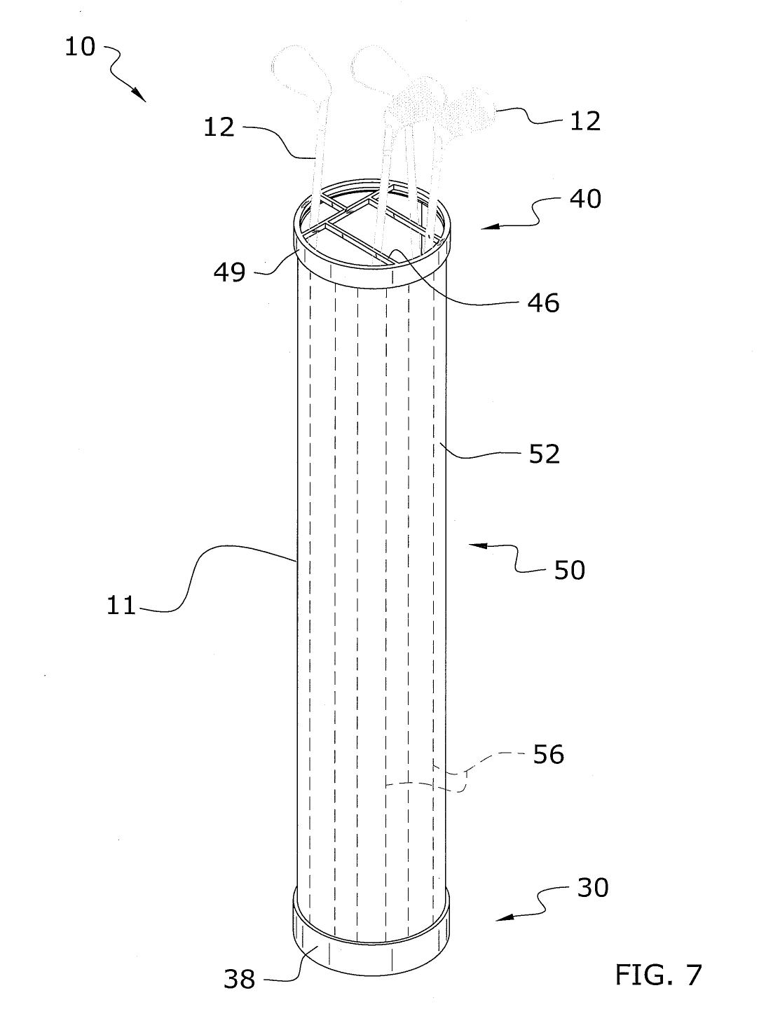

The outer covering 50 will preferably be comprised of a rectangular piece of material which may be rolled into a cylindrically-shaped structure when used in forming a golf bag 11 as shown in FIG. 7. If the material of the outer covering 50 is not stiff enough to provide proper support for the outer covering 50 to be utilized as such, one or more support members 56 may be utilized to provide reinforcement to the outer covering 50. Although different embodiments may be utilized, the support members 56 will preferably be comprised of metal or hard plastic ribs which run from the upper end of the outer covering 50 to its lower end. The support members 56 will preferably be sewn or attached directly into the outer covering 50 so as to limit the effort required in forming a golf bag 11 out of the present invention.

The outer covering 50 will preferably include at least one fastener 54 on its outer surface 52 to engage with the fasteners 32, 42 of the first wheel member 30 and second wheel member 40 as shown in FIG. 6. The fastener 54 of the outer covering 50 may be comprised of various configurations, but is preferably comprised of a hook and loop fastener such as Velcro. Further, in a preferred embodiment, a plurality of strips of fastener 54 will be included on the outer surface 52 of the outer covering 50 at both its upper end and lower end as shown in FIG. 6. Such a configuration allows for a secure connection between the wheel members 30, 40 and the outer covering 50 when the present invention is being utilized as a golf bag 11.

### E. Operation of Preferred Embodiment.

In use, a golfer will place his/her golf clubs 12 and other accessories such as golf shoes and tees within the storage compartment 28 of the travel case 20 and close the cover 22. The golfer may then transport the travel case 20 by pulling its handle 24 to the desired location. If flying, the golfer will only need to pay one baggage fee for the travel case 20, which will generally include two sets of golf clubs 12 and the components necessary to form two golf bags 11 for use on the course.

Upon reaching the golfing destination, the golfer will generally disassemble the travel case 20 to form a pair of golf bags 11. The wheel assemblies 14 will be removed from the axle members 26 of the travel case 20. The wheel assemblies 14 will then be separated into a first wheel member 30 and a second wheel member 40 by sliding the locking member 34 on the first wheel member 30 out of the locking slot 44 of the second wheel member 40 and disengaging the fasteners 32, 42 from each other.

After disconnecting the first wheel member 30 from the second wheel member 40, the travel case 20 may be opened by its cover 22 and the outer covering 50 removed from the storage compartment 28. The outer covering 50 will generally be laid flat, with the first wheel member 30 placed at its lower end and the second wheel member 40 placed at its upper end. The outer covering 50 will then be rolled into a cylindrical shape, with the fasteners 54 at the outer covering's 50 lower end engaging with the fasteners 32 of the first wheel member 30 and the fasteners 54 at the outer covering's 50 upper end engaging with the fasteners 42 of the second wheel member 40.

With the first wheel member 30, second wheel member 40 and outer covering 50 interconnected to form a golf bag 11, the golfer may then place his/her golf clubs 12 into the golf bag 11, utilizing the divider members 46 of the second wheel member 40 to separate different types of clubs 12 from each other. The golfer may then go enjoy his/her sport.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A method of converting a travel case into a golf bag, comprising:
providing a travel case for storing and transporting golf clubs, wherein said travel includes at least one storage compartment;
providing at least one wheel assembly removably attached to said travel case;
providing an outer covering, wherein said outer covering is stored in said at least one storage compartment;
removing said at least one wheel assembly from said travel case;
removing said outer covering from said travel case;
combining said at least one wheel assembly with said outer covering to form a golf bag.

2. The method of converting a travel case into a golf bag of claim 1, wherein said at least one wheel assembly is comprised of a first wheel member and a second wheel member, wherein said first wheel member is removably attached to said second wheel member.

3. The method of converting a travel case into a golf bag of claim 2, wherein said second wheel member includes at least one divider member for separating different types of golf clubs from each other when said golf clubs are stored in said golf bag.

4. The method of converting a travel case into a golf bag of claim 2, wherein said travel case includes an axle member and said first wheel member includes an axle receiving member.

5. The method of converting a travel case into a golf bag of claim 2, wherein said first wheel member includes a locking member, wherein said second wheel member includes a locking slot, wherein said locking member engages with said locking slot to form a connection between said first wheel member and said second wheel member.

6. The method of converting a travel case into a golf bag of claim 2, wherein said first wheel member includes at least one fastener positioned on an inner surface of said first wheel member.

7. The method of converting a travel case into a golf bag of claim 6, wherein said second wheel member includes an outer surface and a recessed surface, wherein at least one fastener is positioned on said recessed surface of said second wheel member.

8. The method of converting a travel case into a golf bag of claim 7, wherein said outer covering includes a first fastener positioned on an upper end of an outer surface of said outer covering, wherein said outer covering includes a second fastener positioned on a lower end of said outer surface of said outer covering.

9. The method of converting a travel case into a golf bag of claim 8, wherein said at least one fastener of said first wheel member engages with said second fastener of said outer covering, wherein said at least one fastener of said second wheel member engages with said first fastener of said outer covering.

10. The method of converting a travel case into a golf bag of claim 1, wherein said travel case includes at least one storage compartment for storing said outer covering.

11. A golf transportation system, comprising:
a travel case for storing and transporting golf clubs;
at least one wheel assembly removably attached to said travel case, wherein said at least one wheel assembly is comprised of a first wheel member removably attached to a second wheel member; and
an outer covering, wherein said first wheel member is adapted to removably attach to a lower end of said outer covering and said second wheel member is adapted to removably attached to an upper end of said outer covering to form a golf bag.

12. The golf transportation system of claim 11, wherein said outer covering includes at least one support member.

13. The golf transportation system of claim 11, wherein said second wheel member includes at least one divider member for separating different types of golf clubs from each other when said golf clubs are stored in said golf bag.

14. The golf transportation system of claim 11, wherein said travel case includes an axle member and said first wheel member includes an axle receiving member.

15. The golf transportation system of claim 11, wherein said first wheel member includes a locking member, wherein said second wheel member includes a locking slot, wherein said locking member engages with said locking slot to form a connection between said first wheel member and said second wheel member.

16. The golf transportation system of claim 11, wherein said first wheel member includes at least one fastener positioned on an inner surface of said first wheel member.

17. The golf transportation system of claim 16, wherein said second wheel member includes an outer surface and a recessed surface, wherein at least one fastener is positioned on said recessed surface of said second wheel member.

18. The golf transportation system of claim 17, wherein said outer covering includes a first fastener positioned on an upper end of an outer surface of said outer covering, wherein said outer covering includes a second fastener positioned on a lower end of said outer surface of said outer covering.

19. The golf transportation system of claim 18, wherein said at least one fastener of said first wheel member engages with said second fastener of said outer covering, wherein said at least one fastener of said second wheel member engages with said first fastener of said outer covering.

20. A golf transportation system, comprising:
a travel case for storing and transporting golf clubs;
a first wheel assembly removably attached to said travel case, wherein said first wheel assembly is comprised of a first wheel member removably attached to a second wheel member, wherein said first wheel assembly includes a first axle receiving member and a first locking member;
wherein said second wheel member includes at least one first divider member and a first locking slot, wherein said first locking member engages with said first locking slot to form a connection between said first wheel member and said second wheel member;
wherein said first wheel assembly includes a first fastener on an inner surface of said first wheel assembly, wherein said second wheel assembly includes a second fastener on an inner surface of said second wheel assembly;
a second wheel assembly removably attached to said travel case, wherein said second wheel assembly is comprised of a third wheel member removably attached to a fourth wheel member, wherein said third wheel member includes a second axle receiving member and a second locking member;
wherein said fourth wheel member includes at least one second divider member and a second locking slot, wherein said second locking member engages with said second locking slot to form a connection between said third wheel member and said fourth wheel member;
wherein said third wheel assembly includes a third fastener on an inner surface of said third wheel assembly, wherein said fourth wheel assembly includes a fourth fastener on an inner surface of said fourth wheel assembly;
a first outer covering including at least one support member, wherein said first wheel member is adapted to removably attach to a lower end of said first outer covering and said second wheel member is adapted to removably attached to an upper end of said first outer covering to form a first golf bag;
wherein said first outer covering includes a first upper fastener on an upper end of an outer surface of said first outer covering, wherein said first outer covering includes a first lower fastener on a lower end of said outer surface of said first outer covering; and
a second outer covering including at least one support member, wherein said second outer covering includes a first upper fastener on an upper end of an outer surface of said second outer covering, wherein said second outer covering includes a second lower fastener on a lower end of said outer surface of said second outer covering;
wherein said first fastener of said first wheel member engages with said first lower fastener of said first outer covering, wherein said second fastener of said second wheel member engages with said first upper fastener of said first outer covering, wherein said third fastener of said third wheel member engages with said first lower fastener of said second outer covering, wherein said fourth fastener of said fourth wheel member engages with said second upper fastener of said second outer covering;
wherein said third wheel member is adapted to removably attached to a lower end of said second outer covering and said fourth wheel member is adapted to removably attached to an upper end of said second outer covering to form a second golf bag, wherein said first fastener of said first wheel assembly engages with said.
